(19) United States
(12) Patent Application Publication
(10) Pub. No.: US 2006/0062544 A1
(43) Pub. Date: Mar. 23, 2006

(54) Apparatus and method for programming a video recording device using a remote computing device

(76) Inventors: Blake P. Southwood, Redwood City, CA (US); Thana Sithanant, Bangkraso (TH); Chao Uei Wahng, Fremont, CA (US); Bangalore Gopal Ravi, Bangalore (IN); Sarath Babu Dhulipalla, San Antonio, TX (US); Ashutosh Tewari, San Jose, CA (US); Yik Chun Un, Macau (PT)

Correspondence Address: Blake P. Southwood, 722 Palomar Drive, Redwood City, CA, 94062, US

(21) Appl. No.: 11/200,858

(22) Filed: Aug. 10, 2005

Related U.S. Application Data
(60) Provisional application No. 60/612,213, filed on Sep. 23, 2004.
(60) Provisional application No. 60/611,665, filed on Sep. 20, 2004.

(51) Int. Cl. H04N 5/76; H04N 5/781

(52) U.S. Cl. 386/46; 386/125

(57) ABSTRACT

A recorder device, such as a VCR, digital video recorder, or the like, that can be programmed from a remote computing device, such as a personal computer mobile personal digital assistant, or cell phone, over a wired and/or wireless network is disclosed. The recording device includes a recording medium configured to record audio and/or video content. A controller, which is coupled to the recording medium, is configured to control the writing of audio and/or video content onto the recording medium and to control the reading of audio and/or video content stored on the recording medium. The recording apparatus also includes a network interface configured to receive recording commands generated by a remote computer and transmitted via a network coupled to the network interface and to provide the received recording commands to the controller, the recording commands defining a selected programming content to be recorded on the recording medium.

### CROSS REFERENCE TO RELATED APPLICATIONS

The present application claims priority under 35 USC §119(e) from U.S. Provisional Application Ser. No. 60/612,213 entitled “Program VRD from PC”, filed Sep. 23, 2004 and U.S. Provisional Application Ser. No. 60/611,665 entitled “Program VRD from PC”, filed Sep. 20, 2004, both incorporated by reference herein for all purposes.

### FIELD OF THE INVENTION

The present invention relates generally to consumer electronics, and more particularly, to an apparatus and method for programming a video recorder, such as a VCR, digital video recorder, or the like, from a remote computing device, such as a personal computer, mobile devices, personal digital assistant, or cell phone, over a wired and/or wireless network.

### BACKGROUND OF THE INVENTION

With the advent of cable and satellite television service, video-on-demand, pay-per view-services, as well as VCR and DVD media that can be rented or purchased, more and more people are using their televisions for home entertainment. Surround sound home theaters, based on CRT based televisions, flat panels such as plasma or CRTs, and even front and rear projection systems are becoming more popular. As life becomes more hectic, however, it is becoming increasingly more difficult for people to be at home or available to watch programming that is broadcast at pre-designated times. Accordingly, recording devices, such as VCRs (video cassette recorders), recordable Digital Video Recorders (DVDs), hard drive based video recorders, offered by such companies like Tivo, are becoming more popular. These recording devices allow a user to record video content and then watch it at their leisure when it is convenient. For example, satellite and cable providers like Direct TV and Comcast are now offering their customers Digital Video Recorders. These devices allow the customer to record a selected television show and then view it at a later time.

There are several problems associated with video recording devices. Foremost, they are often very difficult to program. Certain recording devices, such as VCRs are so complicated to figure out, that most people never use them to record a television show. In most instances, they are simply used as playback devices to play either rented or home movies and the like. DVRs, such as that offered by Tivo, are also problematic for a number of reasons. Foremost, Tivo and other service providers require the payment of a fee for the service. The fee can be a one time charge of several hundred dollars or more. In addition, the Tivo recorder has to be initialized when first used. This typically involves navigating a complicated menu using an infrared remote control to enter the date and time into the device. The user is also required to buy a box from the Tivo along with other installation accessories.

An apparatus and method for programming a video recorder, such as a VCR, digital video recorder, or the like, from a remote computing device, such as a personal computer, mobile devices, personal digital assistant, or cell phone, over a wired and/or wireless network is therefore needed.

### SUMMARY OF THE INVENTION

An apparatus and method for programming a video recorder, such as a VCR, digital video recorder, or the like, from a remote computing device, such as a personal computer, mobile devices, personal digital assistant, or cell phone, over a wired and/or wireless network is disclosed. The recording apparatus includes a recording medium configured to record audio and/or video content. A controller, which is coupled to the recording medium, is configured to control the writing of audio and/or video content onto the recording medium and to control the reading of audio and/or video content stored on the recording medium. The recording apparatus also includes a network interface configured to receive commands or data generated by a remote computer and transmitted via a network coupled to the network interface and to provide the received recording commands or data to the controller, the recording commands defining a selected programming content to be recorded on the recording medium. During operation, the method involves a user generating program commands on a computer coupled to the network. When the program commands are received over the network, the recording apparatus records the requested programming content received from an audio-visual source.

### BRIEF DESCRIPTION OF THE DRAWINGS

The invention, together with further advantages thereof, may best be understood by reference to the following description taken in conjunction with the accompanying drawings in which:

FIG. 1 is a block diagram illustrating an apparatus for programming a video recording device or using a remote computing device according to the present invention.

FIG. 2 is a flow diagram illustrating the sequence of initializing a video recording device from a remote computing device according to the present invention is shown.

FIGS. 3A-3H are a series of graphical user interface screen shots illustrating the sequence for programming a video recording device from a remote computing device according to the present invention.

FIG. 4 is a flow diagram illustrating the sequence for translating programming commands entered by a user through the graphical user interface into a data structure of commands to be sent to the remote video recording device according to the present invention.

FIG. 5 is a block diagram of a video recording device of the present invention.

FIG. 6 is a block diagram of a translation and modulation module in the recording device of the present invention.

FIG. 7 is a block diagram illustrating an arrangement for programming a video recording device according to another embodiment of the present invention.

FIG. 8 is a block diagram illustrating another arrangement for programming a video recording device according to yet another embodiment of the present invention.

FIG. 9 is a block diagram illustrating another arrangement for programming a video recording device according to another embodiment of the invention.

FIG. 10 is a block diagram illustrating another arrangement for programming a video recording device according to another embodiment of the invention.

FIG. 11 is a block diagram illustrating another arrangement for programming a video recording device according to another embodiment of the invention.

In the Figures, like reference numbers refer to like components and elements.

### DETAILED DESCRIPTION OF THE INVENTION

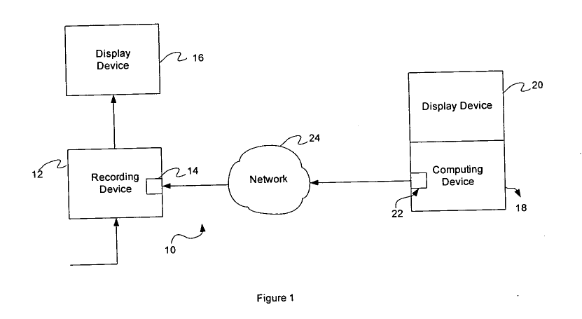

Referring to FIG. 1, a block diagram illustrating an apparatus for programming and providing signals or data to a video recording device using a remote computing device according to the present invention is shown. The apparatus 10 includes a recording device 12 including a network interface 14, a display device 16, and a computing device 18 including a display 20 and a network interface 22. The recording device 12 and the computing device 18 are coupled together over a network 24 via their network interfaces 14 and 22 respectively. According to various embodiments, the term recording device 14 is intended to be all inclusive and can be any type of device capable of recording video and/or audio signals, such as but not limited to, (Video Cassette Recorder) VCRs. digital VCRs, recordable Digital Video Disk (DVD) machines, hard drive based video recording machines such as those made by Tivo, and flash memory video recording machines. The computing device 18 is also intended to be all inclusive and includes personal computers, servers, laptops, hand held computers; personal digital assistants (PDAs), mobile devices, or even a web enabled cell phones. The display device 16 and the display 20 can each be any type of display including but not limited to a CRT, digital HDTV displays, flat screens such as a plasma or LCD panel, a projector, or any other type of display technology currently available or developed in the future. Lastly, the network 24 can be any type of wired or wireless data network, such as the Internet, an intranet, a cellular phone network, local area network, wide area network, or a combination thereof, and may use any type of networking protocol such as but not limited to the internet protocol, Fiber channel, Universal Serial Bus (USB), Ethernet 802.3 or 802.11, Bluetooth, or a combination thereof.

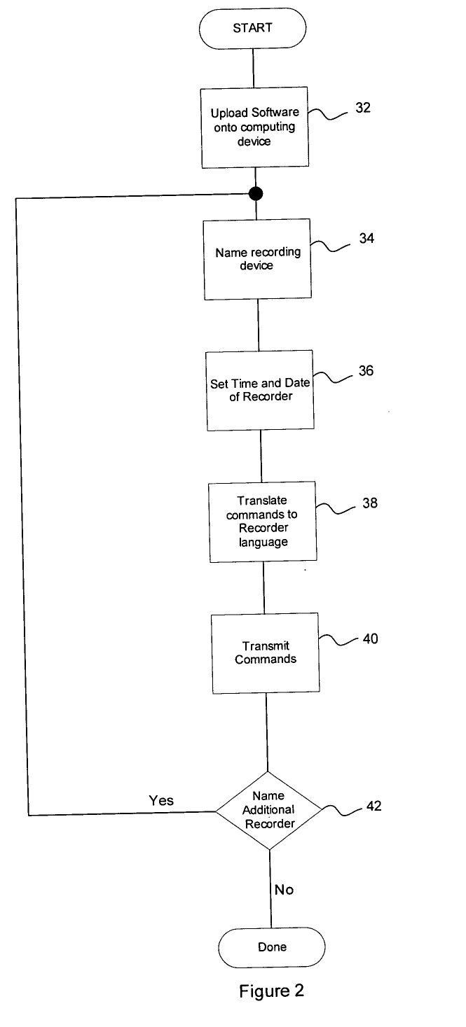

Referring to FIG. 2, a flow diagram 30 illustrating the sequence of initializing a video recording device 12 from a remote computing device 18 according to the present invention is shown. In the initial step, the software is loaded onto the computing device 18 (box 32). The software can be loaded in a variety of ways such from a computer readable disk such as a magnetic disk, CD-ROM, or DVD. The software can also be downloaded over the network 24 from a computer server (not shown) at remote location, such as the web site of the manufacturer of the recording device 12 or some other type of service provider such as a satellite or cable television service provider. Once the software is loaded onto and executed by the computing device 18, it will sequence the user through a number of steps to initialize one or more recording devices 12. As designated by box 34, the software running on the computing device 18 prompts the user to name each recording device 14 they plan program remotely. For example, a given home may have a digital video recorder in their home theater room, a Tivo box in their family room, and a VCR in a bedroom. To differentiate one recording device from another, each machine is arbitrarily assigned a name or identifier by the user, e.g., “Recorder A”, “Recorder B” and “Recorder C”. The date and time for named recording device 12 is then set. This is accomplished by the software prompting the user to enter the date and time into appropriate data entry fields that appear on the display 20 of the computing device 18 (box 36). In response, the software in generates “date” and “time” commands. As described in detail below, the date and time commands are then translated into commands that can be understood or interpreted by the recording device 12 (box 38). The software then directs the computing device 18 to transmit the time and date commands to the recording device 12 over the network 24 (box 40). The above described sequence is repeated for each named recording device designated by the user as denoted by decision diamond 42. After the initialization process is completed, the one or more recording devices 12 may then be programmed to record using a remote computing device 18.

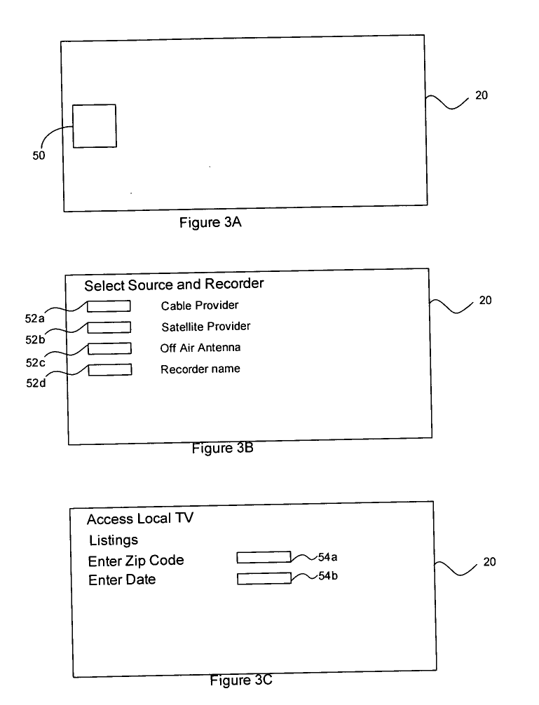

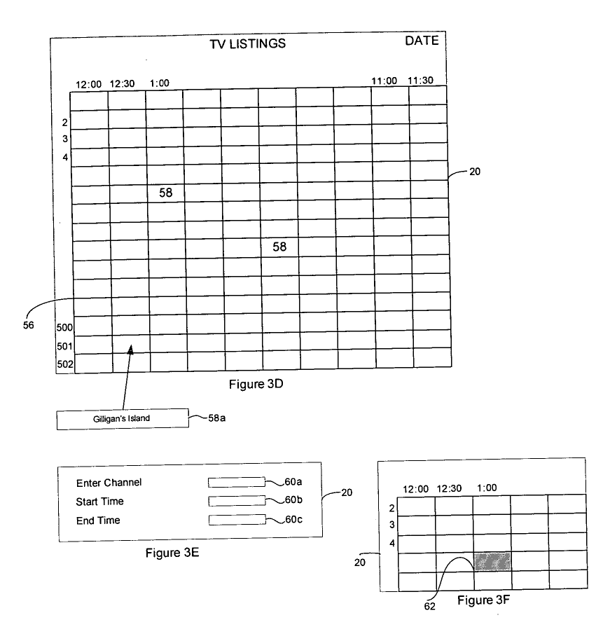

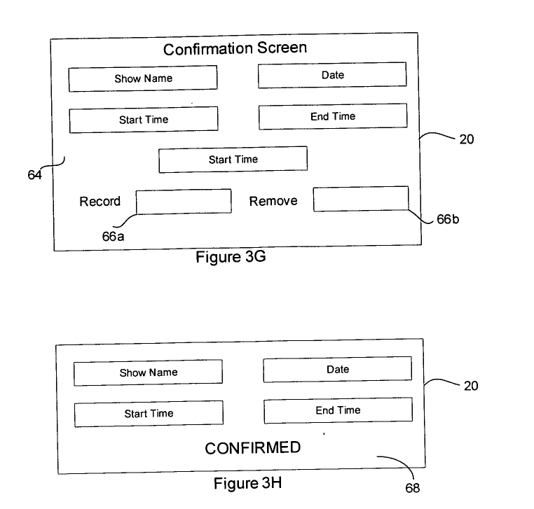

Referring to FIGS. 3A-3H, a series of graphical user interface screen shots displayed on display 20 of computing device 18 illustrating the sequence for programming or a video recording device 12 over the network 24 is shown. These screen shots presume that the aforementioned software has previously been loaded onto computing device 18. In the initial screen shot as illustrated in FIG. 3A, an icon 50 is provided on the display 20. If the computing device is a personal computer for example, the icon 50 resides on the user's desktop appearing on the display 20.

When the icon is selected, for example by a click of a mouse or other data entry device, the programming software is launched.

As illustrated in FIG. 3B, the next screen display requests the user to select the video source and recording device. Data entry field's 52a-52c requires the user to enter the source of programming material they wish to record, i.e., cable, satellite or an over-the-air antenna. Data entry field 52d requests that the name of the recording device they wish to use to record the programming be entered. If the user has defined only a single recording device 12 during initialization, the programming commands will be sent to that recorder by default. Otherwise the programming commands will be sent to the designated recording device 12.

Once the above information has been entered, the software will next display a screen that will enable the access of the local television listings as illustrated in FIG. 3C. This typically entails the user entering their zip code where the recording device 12 is located and the date they wish to record a television show into data entry fields 54a and 54b respectively.

In response, the software will access over the Internet and display the local television listings for the requested zip code and date as illustrated in FIG. 3D. The television listings 56 are displayed in a grid of box 58 having the broadcast channels (2, 3, 4 . . . 500, 501, etc.) listed along the left hand column and the time slots in half-hour increments (12:00AM, 12:30AM . . . 11:30PM) provided along the upper horizontal row. Within each box 58 of the grid 56, the appropriate television programming information is displayed. For example, the television show “Gilligan's Island” is listed in box 58a in the 12:30AM time slot on channel 501. According to various embodiments, the software may accesses the television listings from a number of locations, such as the web site of the local cable or satellite provider or from general web site such as Yahoo! or Google, which typically provide the local television listings.

The grid 56 allows the user to peruse the local television listings and select a program to record. In a first embodiment as illustrated in FIG. 3E, the user is prompted to enter the channel, start time and end time into data entry fields 60a, 60b, and 60c to record programming as provided in the listings 56. In an alternative embodiment, the user can simply select a box 58 or a plurality of boxes 58 on the grid 56 using their mouse to control a curser 62 appearing on the display 20. The software will automatically extract the channel, start and end time for each selected box 58.

Once one or more television programs have been selected using either embodiment described above, the software generates a confirmation screen 64 on the display 20 as illustrated in FIG. 3G. The confirmation screen lists the Show Name, Date, Start Time, End Time, and Name of the Recorder to record the selected programming show. A first data entry field 66a designated “Record” and a second 66b designated “Remove” are also provided. If the Remove data entry field 66b is selected, the record commands are not generated and the software will cause the grid 56 of FIG. 3D to once again be displayed so the user can make another selection. On the other hand, if the Record field 66a is selected, the software generates the channel, date, start and end time commands as necessary to instruct the recording device 12 to record the displayed programming show.

The software generates a confirmed screen 68 on the display 20 as illustrated in FIG. 3H after the commands are generated and sent to the recording device 12.

It should be noted that the contents and sequence of the screen shots provided in FIGS. 3A-3H are exemplary and should in no way be construed as limiting the present invention. In general, any sequence and graphical user interface may be used that captures the basic information needed for programming, such as the date, channel record begin and end times could be used. Furthermore, certain screens, such as those requesting the user's zip code or source of programming, need not be displayed each time the user would like to record a show. Rather, once this information has been entered, it could be treated as default settings and shall remain the same until the user changes the settings.

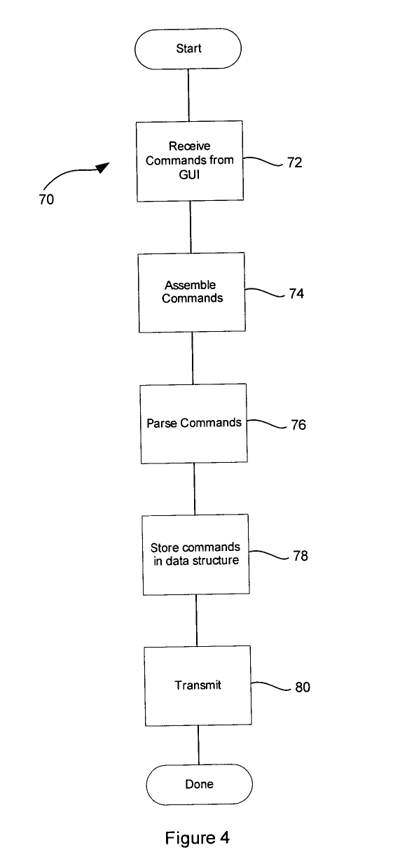

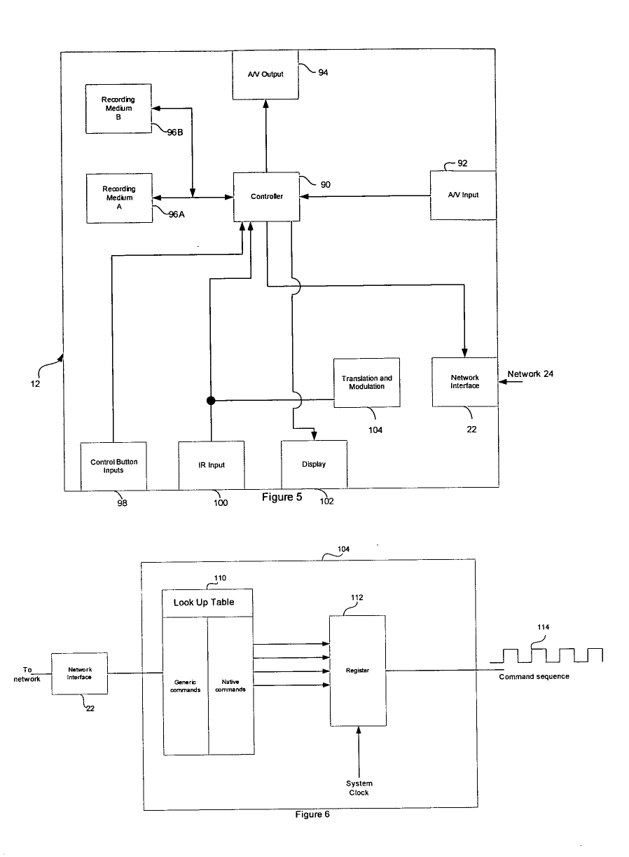

FIG. 4 is a flow diagram 70 illustrating the sequence for translating programming commands entered by a user through the graphical user interface into a data structure of commands to be sent to the remote video recording device according to the present invention. As previously noted above with respect to FIGS. 3A-3H, the user enters basic commands into the computing device 20 through the graphical user interface (box 72). These commands are then provided to an assembler (box 74) which translates the commands into a general format that can be understood by the recording device 12. In other words, the assembler converts the basic commands required for programming (i.e., date, channel, start time, end time, and recorder name) received through the graphical user interface and converts them into commands that mimic those that would ordinarily be generated by the remote control and/or input buttons of the recording device 12. The translated commands are next parsed (box 76) by wrapping the command data in an object and then extracting the needed data from the object. The parser also arranges the commands, in their proper sequence, in a data structure of commands. The data structure of commands is then stored (box 78) before being transmitted (box 80) through the network interface 22 of the computing device 18 to the recording device 12 via the network 24.

Referring to FIG. 5, a block diagram of a video recording device 12 of the present invention is shown. The recording device 12 includes a controller 90 coupled to the an A/V input source 92, an A/V output 94, a first recording medium 96A and an optional second recording medium 96B, a set of input control buttons 98, an infrared (IR) input 100, display 102, network interface 22, and translation and modulation circuit 104. The AN input source 92 is configured to receive an audio-visual signal, such as from a cable or satellite service provider or an off-the-air antenna. The AN output 94 is configured to provide audio and visual signals to the display device 16 and audio equipment either included in the display device 16 or to a separate sound processor such as a surround sound home theater. The actual wire connection between the A/V output 94 and the display and/or audio equipment may include component video, S-Video, composite video, HDMI, digital coax, or an optical output for example. The first and second recording mediums 96A and 96B may any of a number of different storage devices such as analog tape, digital tape, recordable CD-ROMs, recordable DVDs, magnetic memory hard drives, FLASH memory, etc. It should be noted that while the embodiment illustrated shows two recording mediums, this in no way should be construed as limiting. In other embodiments, the recording device 12 may have only one storage medium or more than two storage mediums of the same kind or a combination of the above listed storage mediums. The control input buttons 98 allow a user to control and program the recording device manually. The IR input 100 allows the user to program and control the recording device 12 remotely using a remote control unit (not shown). The display 102 is used to provide status information to the user, such as the time, elapsed time since recording started, recording medium, name of programming material being played back, audio mode, etc. Lastly, the translation and modulation module 104, which is coupled between the network interface 22 and the IR input to the controller 90, is provided to translate the data structure of commands received over the network 24 to the native commands used by the controller 90. The modulator modulates the native commands to be in the same format (i.e., frequency) as if they were transmitted by the remote and received by the IR input 100.

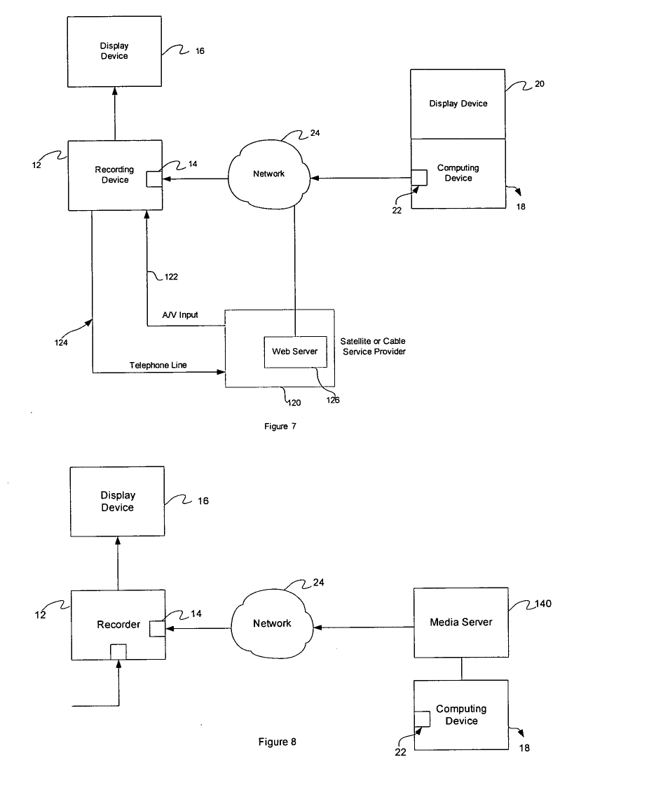

Referring to FIG. 6, a block diagram of the translation and modulation module 104 is illustrated. The module 104 includes a look up table 110 which is configured to generate a native command in response to a generic command received from the network interface. The out put of the look up table 110 is provided to a parallel in-serial out register 112. The register 12 modulates the received native commands and generates a command sequence 114. According to one embodiment for example, if the system clock is at 10 MHz, the register 112 will generate a serial signal output at 40 KHz. Each command in the sequence is 32 bits wide and approximately 20 milliseconds long. The amount of time between successive commands may vary. It should be noted that these parameters are machine dependent and will vary from one recording device to the next. These specific parameters should therefore in no way limit the scope of the invention.

In the aforementioned discussion, only four basic commands were discussed for the sake of simplicity. The present invention, however, contemplates a significantly greater number of commands that can be entered through the graphical user interface, assembled and parsed, and then transmitted in the form of a data structure of generic commands that can be interpreted by the recording device 12. Some of these commands are listed in Table 1 below. The Native Commands listed in the table are for a particular recorder, a JVC Model Number DR-Mh30s/DR-Mh20S. It should be noted that the Native Commands will vary from recording device to recording device. The commands listed in the table are provided for the sake of explaining in general the operation of the present invention by way of example. The specificity of these commands should in no way be construed as limiting the invention

TABLE I

| Generic | Native | |
|---|---|---|
| Command | Command | Function |
| Rewind | REW | Rewind the device |
| Play | PLAY | Play the device |
| Forward | FORWARD | Forward the device |
| Stop | STOP | Stop the device |
| Pause | PAUSE | Pause the device |
| Record | RECORD | Record the device |
| Mem | MEM | Recall the memory of the device |
| 300k | 30OK | Function to enter the data |
| Start+ | START+ | Increment start time of recording |
| Start− | START− | Decrement start time of recording |
| Stop+ | STOP+ | Increment stop time of recording |
| Stop− | STOP− | Decrement stop time of recording |
| Date+ | DATE+ | Increment the date of the device |
| Date− | DATE− | Decrement the date of the device |
| Channel+ | CHANNEL+ | Increment the channel of the device |
| Channel− | CHANNEL− | Decrement the channel of the device |
| Prog | PROG | Program the device |
| Prog ck | PROG CK | Check the programmed device |
| Sp/ep | SP/EP | Adjust length of tape recorder mode |
| Power | POWER | Power up or down the device |
| Timer | TIMER | Program the time of the device |
| 0, 1, 2, 3, 4, | 0, 1, 2, 3, 4, | Numbers are represented as channel, or |
| 5, 6, 7, 8, 9 | 5, 6, 7, 8, 9 | volume of the device |

In the aforementioned discussion, only four basic commands were discussed for the sake of simplicity. The present in an alternative embodiment, the software can be configured to generate the native commands for a particular recording device 12. With this embodiment, the native commands as well as the data or signals would be generated at the computing device 18 and transmitted over the network 24 to the recording device 12 or the display device. It therefore would not be necessary to include the look up table 110 in the recording device 12 to perform the generic to native command translation in this embodiment.

Wireless protocols such as 802.11a, 802.11b, 802.xxx[meaning any 802. protocol] and combination thereof and UWB protocols illustrates an apparatus for programming and providing data or signals to a video recording device using a remote computing device or a mobile device according to another embodiment of the present invention. In this embodiment, a remote computing device or mobile device such as a cell phone, via an RF transceiver or receiver will send signals to the wired network or wireless network such as Internet, an intranet, a cellular phone network, local area network, wide area network, or a combination thereof., and may use any type of networking protocol such as but not limited to the internet protocol, Fiber channel, Universal Serial Bus (USB), Ethernet 802.3 or 802.11, Bluetooth, or a combination thereof. Typically these signals will be received by a wireless/wired router and sends the signals to the [present invention] apparatus using existing network protocols and standards. The wired or wireless router configures the apparatus to assign a designate static IP or dynamic IP. The apparatus so designed receives the signals from the wired/wireless router or other devices such as switches hubs and converts them to an IR signal or data to program the video recording device or display device.

FIG. 7 is a block diagram illustrating an apparatus for programming a video recording device using a remote computing device according to another embodiment of the present invention. In this embodiment, a satellite or cable service provider provides A/V programming material via an A/V connection 122 to the recording device (or a set top box or receiver connected to the recording device 14). The connection 122 is a cable in the case of a cable TV provider and a wireless signal broadcast from a satellite to a satellite receiver located in close proximity to the recording device 14 and display 16. Typically a cable is then connected from the satellite receiver to a set top box coupled to the recording device 14. In the case of satellite providers, a telephone line 124 may also be connected to the recording device 14 and may be accessed using the user's telephone number previously provided to the service provider.

With this embodiment, programming the recording device 14 using the computing device 18 may be implemented in a number of ways. In each instance, the user initializes and inputs programming commands into the computer using the graphical user interface similar to that described above in relation to FIGS. 3A-3H. Once the programming commands have been entered, the commands can be transferred to the recording device 14: (i) directly through the network 24 as described above, bypassing the satellite or cable provider; or (ii) sending the commands to a web server 126 connected to the network 24 located at or under the control of the satellite or cable provider 120. The service provider 120 then sends the commands to the recording device either by the telephone line 124, through the network 24 or over the A/V line 122 in the form of a decoded signal. In one embodiment, the network 24 is the Internet and the web server 126 is configured to receive and send commands over the Internet.

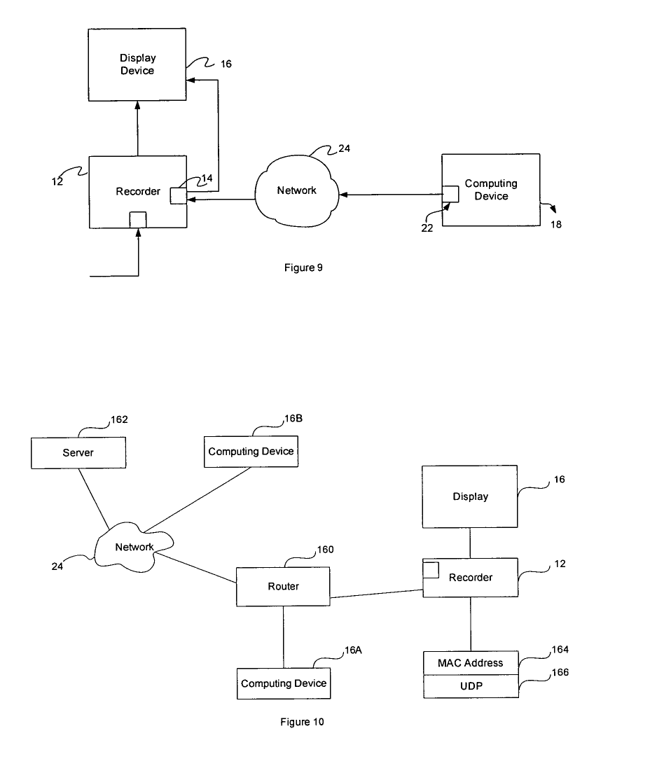

Referring to FIG. 8, a block diagram illustrating another arrangement for programming a video recording device according to yet another embodiment of the present invention. In this embodiment, a media server 140 is coupled between the computer 18 and the network 24. The media server 140 is configured to receive and store video and/or audio signals and store it on a local storage medium, such as a hard drive. The media type involved can be a CD-ROM, Video tapes, USB drives, Fire wire Drive, DVD-R, DVD-RW, and any other storage technology. Media Server can be existing device such as video recording device or computing devices, servers, laptops. This device will record a digital, audio, video data or streams that could be recorded on the storage mentioned above.

Referring to FIG. 9, a block diagram illustrating another arrangement for providing remote digital data or signals or analog signals which can be any form of data such as audio, video and in any format necessary. In this embodiment an Ethernet port, a USB port or a Wireless RF port based on any existing IEEE 802 standards will provide the signals with a bandwidth to sustain a continuous transmission of signals over long period of time to the apparatus. The apparatus converts the signals into any video format such as YCbCr, RGB or S-Video or audio format. The apparatus will also function as a routing mechanism to the any existing video recording and audio recording device.

Referring to FIG. 10, a block diagram illustrating an apparatus for programming a video recording device using a remote computing device according to another embodiment of the present invention is shown. In this embodiment, the recording device 12 is coupled to a router 160 through network interface 14. In various embodiments of the invention, the network connection can be Ethernet (e.g., IEEE 802.3) or a wireless protocol such as WIFI IEEE 802.11b or the Zigbee protocol. A computing device 16A is also connected to the router 160, again using either the aforementioned Ethernet or wireless network solutions. The router 160 acts as an interface between the network 24 and the recording device 12 and the computing device 16A. A second computing device 16B and a server 162 are also connected to the network 24 via ether a wired or wireless network connection. In various embodiments, the recording device 14 is configured to have a unique Medium Access Controller (MAC) address 164 and/or a module to implement the User Datagram Protocol (UDP), Transport Control Protocol (TCP), Real Time Protocol (RTP), and Session Initiation Protocol (SIP) 166.

The arrangement illustrated in FIG. 10 is particularly suited for programming the recording device 12 located in a person's home from a remote location away from the home, such as the office or even while traveling. For example, the recording device 12, display 16, computing device 16A and router 160 can be set up in a person's home. The router is connected to the network, such as the Internet, using an always on cable modem, DSL line, or a similar Internet connection. The second computing device 16B can be located anywhere, such as the person's office or at some other remote site, such as an airport, hotel room, local coffee shop, etc. The arrangement shown in FIG. 10, as described in more detail below, enables the person to program the recording device 12 from a remote location.

Prior to being able to program from a remote location, the programming device 12 needs to be configured to communicate with the router. This can be accomplished in one of several ways. For example, the recording device 12 can initially be connected to the local computing device 16A using a Universal Serial Bus (USB) connection. Once connected through USB, the recording device 12 can be configured to communicate with the router 160 and disconnected from USB. When restarted, the recording device 12 can use the recently configured settings to be able to connect to the router 160. After the connection is established, the router can assign an IP address to the recording device 12. Thereafter, the recording device 12 and the router 160 can communicate with one another. Alternatively, the UDP module can generate UDP message to establish a communicate link between the recording device 14 and the router 160. In either case, the router 160 assigns the recording device a unique “class C” IP address.

Once the recording device 12 has an IP address, it can be programmed from a remote location. For example, if the router 160 has a static IP address, then the remote computer 16B can be used to generate the aforementioned programming commands and to send them to the static IP address of the router 160. The router 160 then routes the commands to the recording device 12 to program the device using port forwarding mechanism. The router can be configured to forward requests for different recording devices coming on different TCP/UDP port.

On the other hand, if the router 160 has a dynamic IP address, then the recording device needs to programmed via a web site provided on the server 162 especially configured to enable users to program their recording devices from remote locations. This entails software on the server that first requires a user to register their devices on server 162. For example, the user may be first required to create a password protected account on the server. Once the account is established the user can program the recording device 12 to fetch information from the server at certain time intervals. Then user programs a specific recording device 12 using the software on 16B. This software sends this information to the server 162, which in-turn, keeps this information. When the recording device 12 connects to the server 162, the server sends this information to the recording device 12. This process of programming the recording device 12, with the help of server 162 can also be done without the above-described software executing on the computing device 16B. Rather, the server 162 can serve web pages to the computing device 16B. Once the account is accessed, the user can sequence through a series of served web pages provided by the server 162 similar to those illustrated in FIGS. 3A through 3H. Server 162 then will collect, assemble, parse and then store the commands, similar to that as described above with regard to FIG. 4. The recording device 12 is configured to periodically access the server 162 and identify itself using its unique MAC address. If the user has provided programming instructions for the recording device 12 having a matching MAC address, the server 162 will download the programming instructions via the network 24, through the router 160, to the recording device 12.

While the embodiment shown in FIG. 10 illustrates only a single recording device 12, it should be noted that this arrangement can easily be configured for multiple recording devices 12 located in the user's home. In such situations, each recording device would be identified with a unique MAC address and class C” IP address. Otherwise, the configuration of each recording device 12 to communicate with the router 160 and the programming of each recording device 12 would essentially be the same as described above. In yet another embodiment, the router can be a switch or any other type of network device having a either a static or dynamic IP address and which is capable of receiving and sending networking messages between the network 24, computing devices 16A and 16B, the server 162, and one or more recording devices 12.

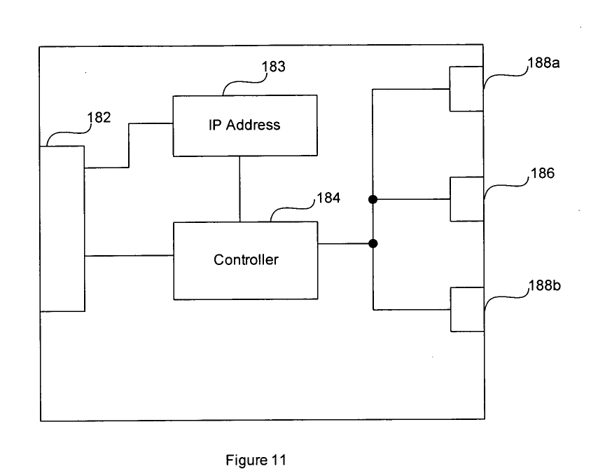

Referring to FIG. 11, a block diagram illustrating an apparatus for programming a video recording device using a remote computing device according to another embodiment of the present invention is shown. In this embodiment, a set top box 180 is used to program a recording device. The set top box 180 includes a network interface 182, an IP address module 183, a controller 184, and an IR transmitter 186. According to various embodiments, the network interface 182 supports one or more of the following: USB; Ethernet (e.g., IEEE 802.3), or wireless protocols such as Bluetooth, WIFI (IEEE 802.11b) or the Zigbee protocol. Regardless of the protocol, the network interface 182 is configured to receive programming commands as described above as well as streaming video and other content. In various embodiments, the IP address module 183 can have either a static or dynamic IP address and can support level three through five protocols. This allows programming commands to be sent to the set top box, as described above with regard to FIG. 10. Accordingly, the set top box 180 is capable of communicating using any layer 4 protocol such as UDP (user datagram protocol), SIP (session in protocol), TCP (transport control protocol), and RTP (real time protocol) for media player. The controller 184 is similar to the controller 90 described above, namely it is capable of receiving generic programming commands and converting them to native commands of a target programming device 12. With this embodiment, the controller 184 can be programmed to include the native commands of numerous programming devices. The user then has to inform the set top box 180 of the type of programming device they are using so that the correct translation can occur. In an alternative embodiment, the controller 184 can pass received native commands and provide them to the programming device. The set top box 180 also includes an IR transmitter for transmitting commands and other data to the programming device. In other words, the controller 184 is capable of generating and transmitting programming commands received from a remote computer and through the network interface 182 and providing them to the programming device 12 via the IR transmitter. In this way, the functionality of the remote control unit of the programming device 12 can be mimicked. The set top box also includes addition al hard wire ports 188a and 188b for providing commands, streaming video and other data and content to the programming device and/or a display device 16.

Although the foregoing invention has been described in some detail for purposes of clarity of understanding, it will be apparent that certain changes and modifications may be practiced within the scope of the appended claims. For example, the processes and techniques described herein can be applied to individual dice as opposed to the wafer level. Therefore, the described embodiments should be taken as illustrative and not restrictive, and the invention should not be limited to the details given herein but should be defined by the following claims and their full scope of equivalents.

We claim:

1. A recording apparatus, comprising:
a recording medium configured to record audio and/or video content;
a controller, coupled to the recording medium, and configured to control the writing of audio and/or video content onto the recording medium and to control the reading of audio and/or video content stored on the recording medium; and
a network interface configured to receive recording commands generated by a remote computer and transmitted via a network coupled to the network interface and to provide the received recording commands to the controller, the recording commands defining a selected programming content to be recorded on the recording medium.

2. The recording apparatus of claim 1, further comprising a translation module, coupled between the network interface and the controller, the translation module configured to receive generic recording commands from the network interface and to translate them into native commands understood by the controller of the recording apparatus.

3. The recording apparatus of claim 1, further comprising a modulation module, coupled between the network interface and the controller, the translation module configured to modulate the recording commands to emulate the commands generated by a remote control used to control the recording apparatus.

4. The recording apparatus of claim 1, further comprising an audio-visual input coupled to the controller, the audio-visual input configured to receive programming content.

5. The recording apparatus of claim 4, wherein the audio-visual input is configured to receive programming content from at least one of the following: a cable TV service provider, a satellite TV service provider, or an off the air broadcast.

6. The recording apparatus of claim 1, wherein the recording medium comprises one of the following types of recording mediums: analog tape, digital tape, recordable CD-ROM, recordable DVD, a magnetic memory storage disk, or FLASH memory.

7. The recording apparatus of claim 1, further comprising an audio-visual output, coupled to the controller, and figured to output audio and/or video content.

8. The recording apparatus of claim 7, wherein the audio and/or video content provided at the audio-visual output is stored on the recording medium.

9. The recording apparatus of claim 7, wherein the audio-visual output comprises one of the following types of outputs: component video, S-video, composite vide, digital coax, an optical output, or HDMI.
